(19) United States
(12) Patent Application Publication
(10) Pub. No.: US 2009/0278777 A1
(43) Pub. Date: Nov. 12, 2009

(54) PIXEL CIRCUIT AND DRIVING METHOD THEREOF

(75) Inventors: Hsien-Chun Wang, Taoyuan County (TW); Tzu-Chien Huang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/211,827

(22) Filed: Sep. 17, 2008

(30) Foreign Application Priority Data
May 8, 2008 (TW) 97116989

(51) Int. Cl. G09G 3/36

(52) U.S. Cl. 345/89; 345/100

(57) ABSTRACT

A pixel circuit and a driving method thereof are provided. The pixel circuit includes a pixel capacitor, a storage capacitor, a first transistor and a second transistor. A common node is between the storage capacitor and the pixel capacitor. The first transistor is electrically connected between a data line and the common node, and a gate thereof is electrically connected to a first gate line. The second transistor is electrically connected between the common node and a gray level voltage, and a gate thereof is electrically connected to a second gate line. The first gate and the second gate line are adjacent.

### CROSS-REFERENCE TO RELATED APPLICATION

This application claims the priority benefit of Taiwan application serial no. 97116989, filed May 8, 2008. The entirety of the above-mentioned patent application is hereby incorporated by reference herein and made a part of this specification.

### BACKGROUND OF THE INVENTION

1. Field of the Invention

The present invention relates to a black frame insertion technology, and particularly to a pixel circuit applied to black/gray frame insertion and a driving method thereof.

2. Description of Related Art

Demand for liquid crystal displays (LCDs) has been growing rapidly in recent years and development towards large sizes gradually becomes the trend. As the size of LCD panels increases, not only does the resolution thereof enhance but demand for television dynamic image display also significantly increases. Since the LCD is driven by a hold-type method rather than an impulse-type method of the cathode ray tube (CRT) and liquid crystals in the LCD respond more slowly, blurred images, draggle or color shift would occur while displaying a dynamic image.

As consumers demand more and more strictly of dynamic image quality, how to eliminate the blur effect caused by hold-type displays gradually becomes a primary issue. A black frame insertion technology is one of the solutions. Currently, technologies aiming at solving the issue of blurred dynamic image are mainly divided into three categories, including doubling frequencies, dynamic backlight control and black frame data insertion. The purpose of all these technologies is to change a hold-type driving method of the LCD into a driving method similar to a pulse-type driving method such that better dynamic image display quality can be achieved.

As disclosed by U.S. Patent Publication No. 2006/0164380, the black insertion technology provided therein divides an LCD panel into a plurality of display regions, and multiplexers and algorithms are used to determine the display regions for black frame insertion. The more display regions the LCD panel is divided into, the better effect black frame insertion would obtain. However, the number of the divided display regions is limited by the resolution of the LCD panel and has its maximum. Accordingly, the higher the resolution of the LCD panel is, the more this technology improves on the effect of black frame insertion.

Further, a technology directed to improving dynamic image quality provided by U.S. Pat. No. 6,819,311 is characterized by disposing two independent transistors in a pixel and using independent gate drivers and source drivers to write data in the pixels and perform black frame insertion so as to improve display quality of the dynamic image. However, since the panel requires a doubled number of gate lines and two sets of independent driving chips, the driving circuit of the panel is designed as more complicated and thereby costing more.

### SUMMARY OF THE INVENTION

The present invention is directed to a pixel circuit. A transistor is added on a pixel electrode and an enabling signal of a gate line is used to conduct a bias of the pixel electrode to a gray level voltage or a common voltage so as to achieve the effect of black/gray frame insertion.

The present invention is directed to a display panel to be coordinated with the pixel circuit of the present invention. When a gate line is enabled, the enabled gate line can write data and perform black frame insertion to pixels in two pixel columns respectively to enhance display quality of a dynamic image.

The present invention provides a driving method adapted to a display panel of the present invention. First, an image cycle is divided into a first period and a second period. Odd-numbered gate lines are driven during the first period, and even-numbered gate lines are driven during the second period. By driving by every other line, data-writing and black/gray frame insertion are both completed in the same image cycle so as to improve image display quality. The present invention provides a display panel including N pixel columns, N gate lines and a plurality of data lines. Each of the pixel columns has a plurality of pixels and the gate lines correspond to the pixel columns. An (i+1)^{th} gate line is electrically connected to an i^{th} pixel column and the pixels corresponding to the (i+1)^{th} pixel column. i is a positive integer and 1≦i<N. Moreover, the plurality of data lines corresponds to the pixels in the pixel columns. When the (i+1)^{th} gate line is enabled, the (i+1)^{th} pixel column is turned on to receive a plurality of pixel driving voltages transmitted by the data lines, and the i^{th} pixel column receives a gray level voltage to perform black/gray frame insertion. According to an embodiment of the present invention, in the said display panel, each of the pixel circuits on the i^{th} pixel column includes a first pixel capacitor, a first storage capacitor, a first transistor and a second transistor. The first pixel capacitor is electrically connected between a first common node and a common voltage. One end of the first storage capacitor is electrically connected to the first common node. The first transistor is electrically connected between one of the data lines corresponding thereto and the first common node, and a gate of the first transistor is electrically connected to the i^{th} gate line. The second transistor is electrically connected between the first common node and a first gray level voltage, and a gate of the second transistor is electrically connected to the (i+1)^{th} gate line.

According to an embodiment of the present invention, each of the pixel circuits in the i^{th} pixel column further includes a coupling capacitor, a second pixel capacitor, a second storage capacitor and a third transistor. The coupling capacitor is electrically connected between the first common node and a second common node, and the second pixel capacitor is electrically connected between the second common node and the common voltage. One end of the second storage capacitor is electrically connected to the second common node, and the third transistor is electrically connected between the second common node and a second gray level voltage. A gate of the third transistor is electrically connected to the (i+1)^{th} gate line.

According to an embodiment of the present invention, the other end of the first storage capacitor is electrically connected to the first gray level voltage or the common voltage. The other end of the second storage capacitor is electrically connected to the second gray level voltage or the common voltage.

According to an embodiment of the present invention, the first gray level voltage and the second gray level voltage may be equal to the common voltage or correspond to a voltage value of a gray level image.

According to an embodiment of the present invention, each of the pixel circuits in the i^{th} pixel column includes a first pixel capacitor, a first storage capacitor, a first transistor, a second transistor, a second pixel capacitor, a second storage capacitor and a third transistor. The first pixel capacitor is electrically connected between the first common node and the common voltage, and one end of the first storage capacitor is electrically connected to the first common node. The first transistor is electrically connected between one of the data lines corresponding thereto and the first common node. The gate of the first transistor is electrically connected to the i^{th} gate line. The second transistor is electrically connected between the first common node and the second common node. The gate of the second transistor is electrically connected to the i^{th} gate line. The second pixel capacitor is electrically connected between the second common node and the common voltage. One end of the second storage capacitor is electrically connected to the second common node. The third transistor is electrically connected between the second common node and the first gray level voltage. The gate of the third transistor is electrically connected to the (i+1)^{th} gate line.

According to an embodiment of the present invention, the other ends of the first storage capacitor and the second storage capacitor are electrically connected to the first gray level voltage or the common voltage.

From another viewpoint, the present invention further provides a pixel circuit applicable to black/gray frame insertion. The pixel circuit includes a first pixel capacitor, a first storage capacitor, a first transistor and a second transistor. The first pixel capacitor is electrically connected between the first common node and the common voltage. One end of the first storage capacitor is electrically connected to the first common node. The first transistor is electrically connected between the data line and the first common node, and the gate of the first transistor is electrically connected to a first gate line. The second transistor is electrically connected between the first common node and the first gray level voltage, and the gate of the second transistor is electrically connected to a second gate line. The first gate line and the second gate line are adjacent.

The present invention further provides a pixel circuit including a first pixel capacitor, a first storage capacitor, a first transistor, a second transistor, a second pixel capacitor, a second storage capacitor and a third transistor. The first pixel capacitor is electrically connected between the first common node and the common voltage and one end of the first storage capacitor is electrically connected to the first common node. The first transistor is electrically connected between the data line and the first common node, and the gate of the first transistor is electrically connected to a first gate line. The second transistor is electrically connected between the first common node and the second common node, and the gate of the second transistor is electrically connected to the first gate line. The second pixel capacitor is electrically connected between the second common node and the common voltage. One end of the second storage capacitor is electrically connected to the second common node. The third transistor is electrically connected between the second common node and the first gray level voltage, and the gate of the third transistor is electrically connected to a second gate line. The first gate line and the second gate line are adjacent.

In order to be in coordination with the said display panel and pixel circuit, the present invention provides a driving method adapted to driving the said display panel. The display panel includes N pixel columns corresponding to N gate lines respectively. When the (i+1)^{th} gate line is enabled, the (i+1)^{th} pixel column is turned on to receive the plurality of pixel driving voltages outputted by the data lines. The i^{th} pixel column receives a gray level voltage to perform black/gray frame insertion; N and i are positive integers and 1≦i<N. The driving method includes dividing an image cycle into a first period and a second period. During the first period of the image cycle, odd-numbered gate lines among the gate lines are scanned sequentially. During the second period of the image cycle, even-numbered gate lines among the gate lines are scanned sequentially.

According to an embodiment of the present invention, the second period may follow the first period or the first period may follow the second period.

In the present invention, a unique pixel circuit and a unique structure design are integrated into the display panel to be coordinated with the driving method of scanning by every other line. Consequently, the pixel circuits in the display panel synchronously perform data writing and black/gray frame insertion on adjacent pixel columns while the gate lines are enabled. As to circuit design, the present invention only requires adding transistors to the pixel structure for black/gray frame insertion so as to be adapted to most LCDs and does not need additional design on the driving circuit. As a result, the effect of black/gray frame insertion is achieved with a lower cost.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a display according to an embodiment of the present invention.

FIG. 2 is a timing diagram of signals according to an embodiment of the present invention.

FIG. 3 is a driving status diagram of a display panel according to an embodiment of the present invention.

FIG. 4 is a driving status diagram of the gate lines according to the first embodiment of the present invention.

FIG. 5A is a pixel circuit diagram according to the second embodiment of the present invention.

FIG. 5B is a pixel layout diagram according to FIG. 5A.

FIG. 6A is a pixel circuit diagram according to the third embodiment of the present invention.

FIG. 6B is a pixel layout diagram according to FIG. 6A.

FIG. 7A is a pixel circuit diagram according to the fourth embodiment of the present invention.

FIG. 7B is a pixel layout diagram according to FIG. 7A.

FIG. 8 is a flowchart illustrating the driving method of the display according to the present invention.

### DESCRIPTION OF EMBODIMENTS

### The First Embodiment

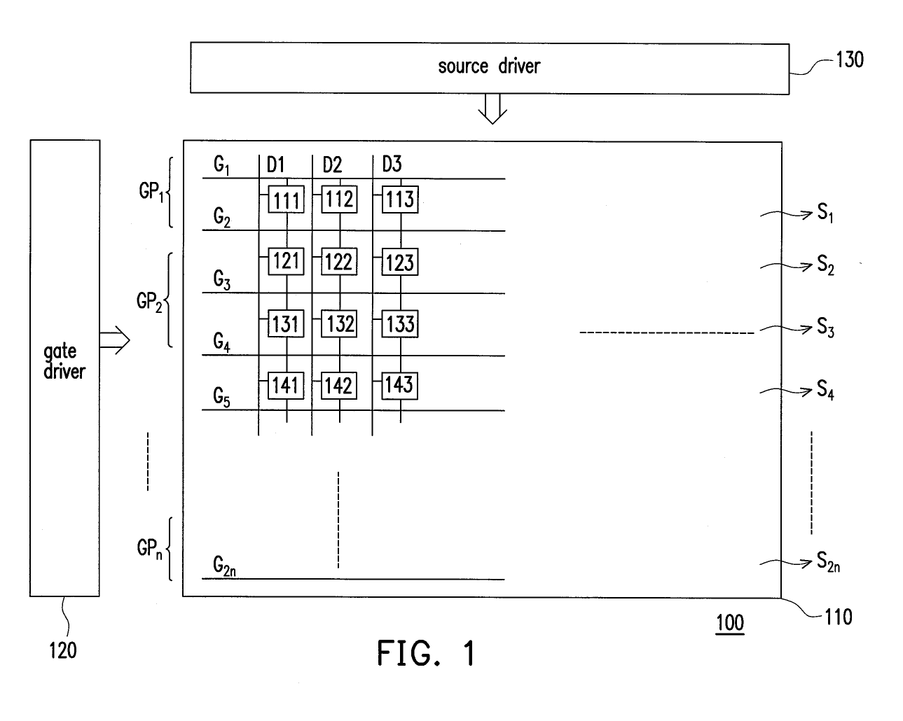

FIG. 1 is a circuit diagram of a display according to an embodiment of the present invention. A liquid crystal display (LCD) 100 includes a display panel 110, a gate driver 120 and a source driver 130. The display panel 110 includes pixel columns S₁-S₂ₙ and gate lines G₁-G₂ₙ; n is a positive integer. The gate driver 120 is used for transmitting gate scan signals, and the source driver 130 is used for transmitting pixel driving signals. In the present embodiment, all pixels corresponding to a gate line are represented by a pixel column. Accordingly, each of the pixel columns has a plurality of pixels and a pixel circuit represents an equivalent circuit of a pixel structure.

In the display panel 110, each of the pixel columns S₁-S₂ₙ includes a plurality of pixel circuits (e.g. 111-113, 121-123, 131-133) and is electrically connected to adjacent gate lines G₁-G₂ₙ over and under the pixel column correspondingly. Each of the gate lines G₁-G₂ₙ is likewise electrically connected to adjacent pixel circuits over and under the gate lines. Taking the gate line G₂ for example, the pixel circuits 111-113 and 121-123 are all electrically connected to the gate line G₂. When the gate line G₂is enabled, the pixel circuits 121-123 corresponding to the pixel column S₂ are turned on and receive pixel driving voltages transmitted by data lines D1-D3. The pixel circuits 111-113 corresponding to the pixel column S₁ are conducted to a gray level voltage to perform black/gray frame insertion. Therefore, when the gate line G₂ is enabled, one of the adjacent pixel columns of the gate line G₂ performs normal data writing, and another pixel column performs black/gray frame insertion. A method of operating the remaining gate lines is the same as the aforementioned and is thus not reiterated.

Utilizing the characteristics as described above, in the present embodiment, a driving method of scanning by every other gate line is adopted. An image cycle is divided into two periods; odd-numbered gate lines (e.g. G₁, G₃, G₅ . . . ) are first scanned and then even-numbered gate lines (e.g. G₂, G₄, G₆ . . . ) are scanned. A sequence of scanning may be determined according to different driving methods. Taking adjacent gate lines Gₙ and Gₙ₊₁ for example, when the gate line Gₙ is enabled, half an image cycle has to pass until the gate line Gₙ₊₁ is enabled. When odd-numbered gate lines are scanned, odd-numbered pixel columns corresponding thereto (e.g. S₁, S₃, S₅ . . . ) perform writing of normal signals while even-numbered pixel columns (e.g. S₂, S₄, S₆ . . . ) perform black/gray frame insertion. On the other hand, when even-numbered gate lines are scanned, even-numbered pixel columns corresponding thereto (e.g. S₂, S₄, S₆ . . . ) perform writing of normal signals while odd-numbered pixel columns (e.g. S₁, S₃, S₅ . . . ) perform black/gray frame insertion. Thus, each of the pixel columns lasts for half an image cycle after the data writing (i.e., receiving the pixel driving voltage) and then performs black/gray frame insertion (i.e., receiving a gray level voltage of the black frame or gray frame) for half an image cycle.

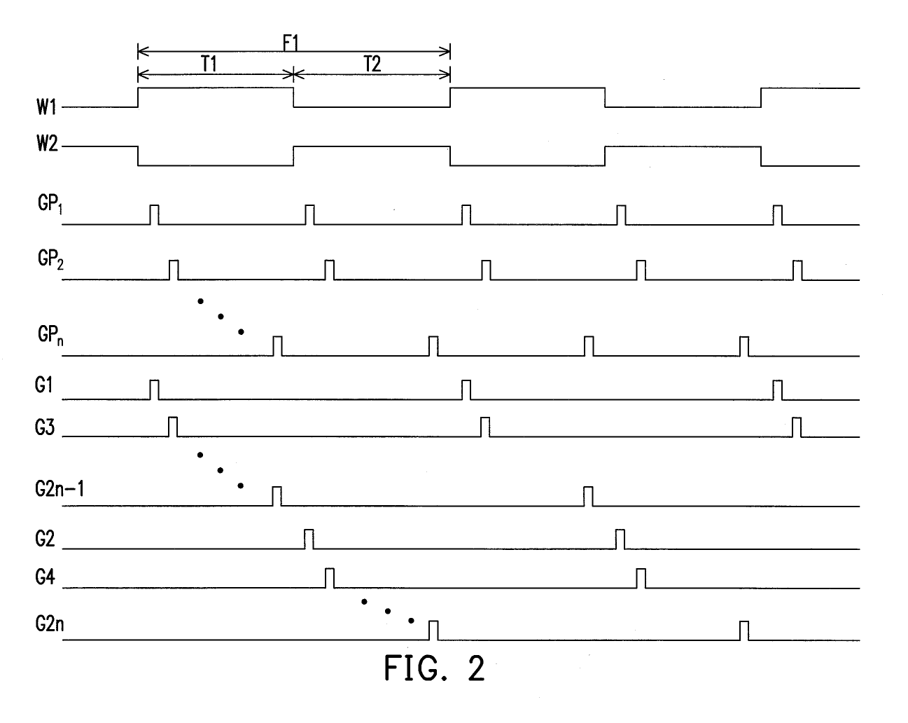

Afterwards, referring to the waveform of FIG. 2 for further description of the driving method of the present invention, FIG. 2 is a signal timing diagram according to the present embodiment. Waveforms W1 and W2 represent driving timings of different driving polarities. Taking a first image F1 for example, the image cycle is divided into a first period T1 and a second period T2, and a scanning method thereof is illustrated as FIG. 2. During the first period T1, odd-numbered gate lines (G₁, G₃, G₅ . . . G₂ₙ₋₁) are scanned sequentially. During the second period T2, even-numbered gate lines (G₂, G₄, G₆ . . . G₂ₙ) are scanned sequentially.

In addition, with the driving method of the present embodiment, the gate driver 120 only requires half the number of gate driving signals GP₁-GPₙ to drive the gate lines G₁-G₂ₙ of the entire display panel 110. Since during the same period (T1 or T2), only half of the gate lines (odd-numbered or even-numbered ones) need to be driven, the gate driving signals GP₁-GPₙ may scan the odd-numbered gate lines (G₁, G₃, G₅ . . . G₂ₙ₋₁) during the first period T1 and then switch to scan the even-numbered gate lines (G₂, G₄, G₆ . . . G₂ₙ) during the second period T2. In a circuit design of the gate driver 120, a switch may be set to switch a transmission path of the gate driving signals GP₁-GPₙ. During the first period T1 the switch switches to the odd-numbered gate lines, and during the second period T2 the switch switches to the even-numbered gate lines. According to another embodiment of the present invention, in the aforesaid driving method, the even-numbered gate lines (G₂, G₄, G₆ . . . G₂ₙ) may also be driven first and then the odd-numbered gate lines (G₁, G₃, G₅ . . . G₂ₙ₋₁) are driven.

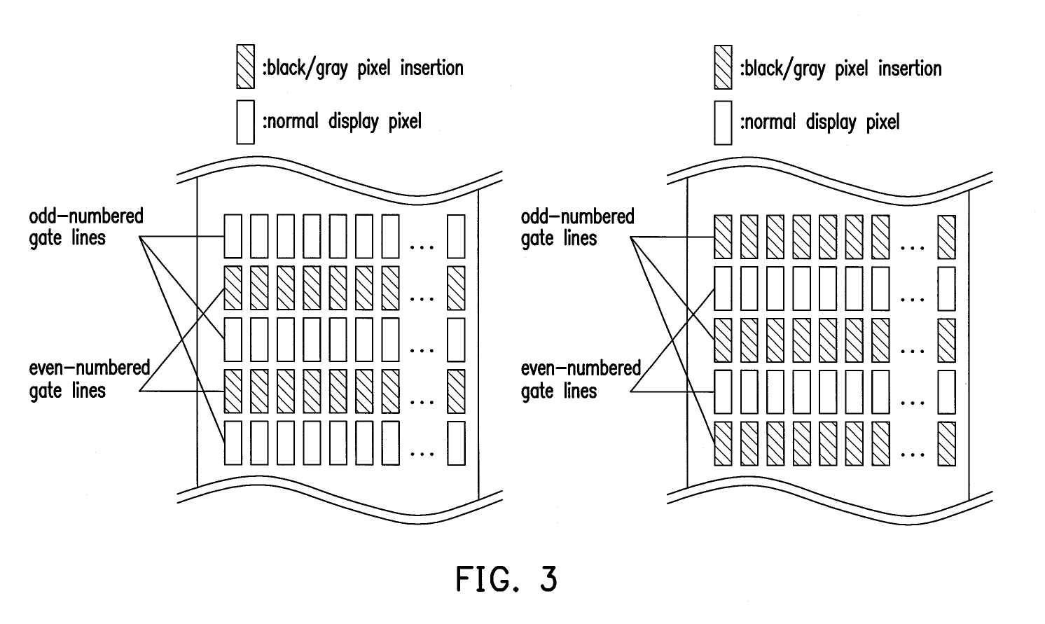

FIG. 3 is a driving status diagram of a display panel according to the present embodiment of the present invention. The left drawing in FIG. 3 illustrates the driving status during the first period T1. Blank blocks signify that the pixels of the odd-numbered gate lines (G₁, G₃, G₅ . . . G₂ₙ₋₁) are in a normal display status and blocks with oblique lines signify that the pixels of the even-numbered gate lines (G₂, G₄, G₆ . . . G₂ₙ) are in a status of black/gray frame insertion. The right drawing of FIG. 3 illustrates the driving status during the second period T2. In this drawing, the display statuses of the odd-numbered gate lines (G₁, G₃, G₅ . . . G₂ₙ₋₁) and the even-numbered gate lines (G₂, G₄, G₆ . . . G₂ₙ) are exchanged.

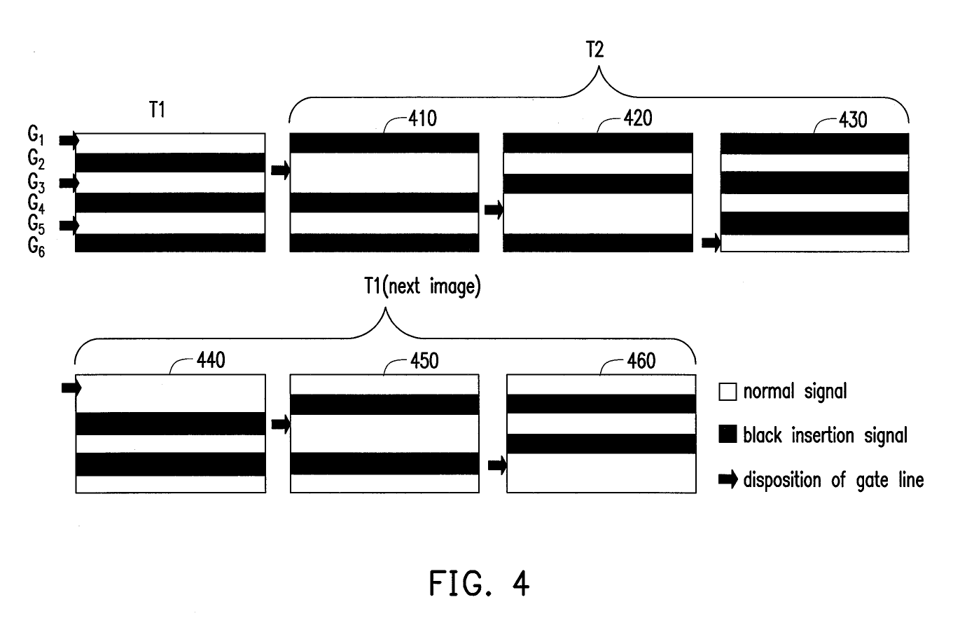

FIG. 4 is a driving status diagram of the gate lines according to the first embodiment of the present invention. In FIG. 4, only a portion of the gate lines, G₁-G₆, in the display panel 110 are taken as an example for illustration. During the first period T1, the gate driver 120 drives the gate lines G₁, G₃ and G₅ sequentially. The pixels corresponding to the gate lines G₂ and G₄ (i.e., the pixel circuits on the pixel columns S₂ and S₄, such as 121-123 and 141-143) are conducted to gray level voltages because the gate lines G₃ and G₅ are enabled. While entering the second period T2, the gate lines G₂, G₄ and G₆ are driven sequentially, which are respectively illustrated by images 410-430. In the image 410, the gate line G₂is enabled. Therefore, the pixels corresponding to the gate line G₁ are conducted to gray level voltages to perform black/gray frame insertion. The gate line G₂ performs normal data writing while the pixels of the gate line G₃ still maintain their hold-type statuses. Likewise, the display statuses of the enabled gate lines G₄ and G₆ are illustrated by the images 420 and 430. While entering the first period T1 of the next image, the odd-numbered gate lines G₁, G₃ and G₅ are enabled sequentially and their display statuses are illustrated by images 440-460 respectively. Since the details of operation are similar to those described above, they are not to be reiterated.

### The Second Embodiment

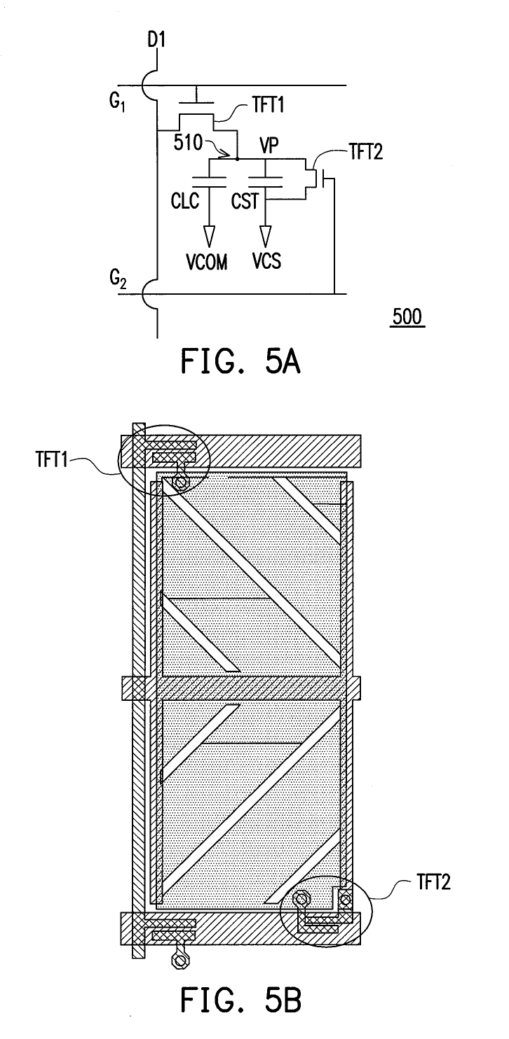

Next, the pixel circuit of the present invention is further described using a pixel circuit 111 as an example. FIG. 5A illustrates a pixel circuit diagram according to the second embodiment of the present invention. A pixel circuit 500 shows one of a variety of embodiments for the pixel circuit 111. The pixel circuit 500 includes transistors TFT1 and TFT2, a pixel capacitor CLC and a storage capacitor CST and is electrically connected between adjacent gate lines G₁ and G₂. The pixel capacitor CLC and the storage capacitor CST have a common node 510. The other end of the pixel capacitor CLC is electrically connected to a common voltage VCOM (a ground voltage level or a specific voltage level), and the storage capacitor CST is electrically connected between the common node 510 and a gray level voltage VCS. The transistor TFT1 is electrically connected between the data line D1 and the common node 510, and a gate of the transistor TFT1 is electrically connected to the gate line G₁. The transistor TFT2 is electrically connected between the common node 510 and the gray level voltage VCS, and a gate of the transistor TFT2 is electrically connected to the gate line G₂.

A voltage on the common node 510 is called a pixel driving voltage VP. The pixel driving voltage VP is mainly provided by the data line D1. When the gate line G₁ is enabled, the transistor TFT1 is turned on and the data line D1 transmits the pixel driving voltage VP to the common node 510 to charge the pixel capacitor CLC and the storage capacitor CST. When the gate line G₂ is enabled, the transistor TFT2 is conducted and a voltage level (originally the pixel driving voltage VP) of the common node 510 is thus affected by the gray level voltage VCS and changed to the gray level voltage VCS. Hence, the pixel circuit 111 displays a black image or a gray image according to the changed pixel driving voltage VP. If the gray level voltage VCS is equal to the common voltage VCOM, a voltage difference between the two ends of the pixel capacitor CLC approaches zero and a tilt angle of liquid crystals approaches to being closed. As a result, the pixel circuit 111 has the effect of black frame insertion. If the gray level voltage VCS is not equal to the common voltage VCOM, the pixel circuit 111 displays gray images with different gray levels as a voltage value of the gray level voltage VCS changes. Accordingly, the gray level voltage VCS can be adjusted to set a gray level value of an inserted gray image. In the display panel 110, an equivalent circuit of the remaining pixels is the same as that of the pixel circuit 111 and thus is not reiterated herein.

FIG. 5B is a pixel layout diagram according to FIG. 5A. A primary difference between the present embodiment and the prior art lies in the transistor TFT2. The transistor TFT2 is located on the lower right corner of the pixel and electrically connected in series to the storage capacitor. In the present embodiment, a pixel electrode layout pattern may be changed to suit various display requirements and is thus not defined herein.

### The Third Embodiment

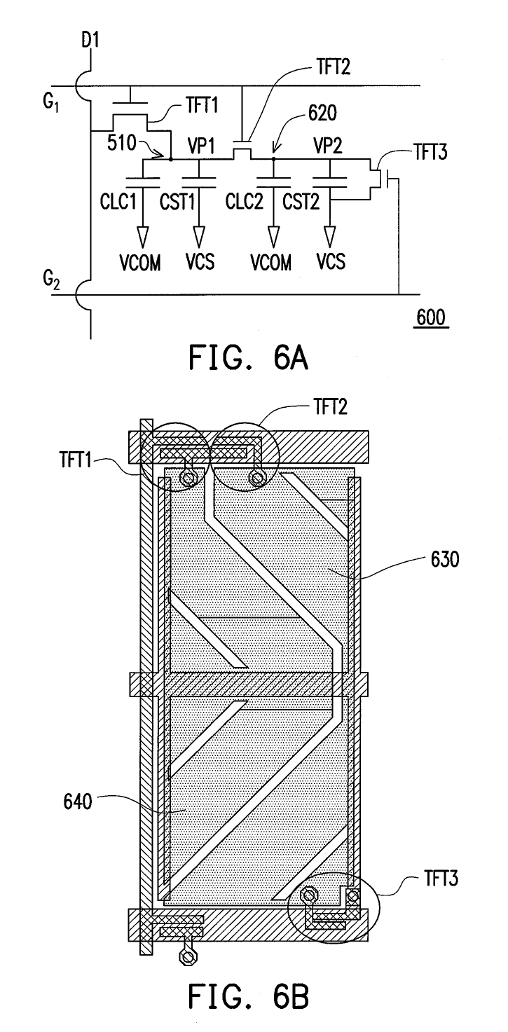

Thereafter, in the present invention, the circuit design concept disclosed by the second embodiment is applied to a variety of pixel structures. FIG. 6A is a pixel circuit diagram according to the third embodiment of the present invention. Likewise, the current location of the pixel circuit 111 is taken as an example, and a pixel circuit 600 illustrates another embodiment of the pixel circuit 111. The pixel circuit 600 includes transistors TFT1-TFT3, pixel capacitors CLC1 and CLC2 and storage capacitors CST1 and CST2. In the present embodiment, the pixel circuit 600 is mainly constituted by two sub-pixel structures. The pixel capacitor CLC1 and the storage capacitor CST1 form a sub-pixel. The pixel capacitor CLC2 and the storage capacitor CST2 form the other sub-pixel. Such pixel structure has various applications, for example, in LCDs with wide view angle.

A circuit structure consisting of the pixel capacitor CLC1, the storage capacitor CST1 and the transistor TFT1 is similar to that of FIG. 5A and therefore is not reiterated. One end of each of the pixel capacitor CLC2 and the storage capacitor CST2 is electrically connected to a common node 620. The other end of the pixel capacitor CLC2 is electrically connected to the common voltage VCOM, and the other end of the storage capacitor CST2 is electrically connected to the gray level voltage VCS. The transistor TFT3 is electrically connected between the common node 620 and the gray level voltage VCS, and a gate of the transistor TFT3 is electrically connected to the gate line G₂. The transistor TFT2 is electrically connected between the common node 620 and the common node 510, and the gate of the transistor TFT2 is electrically connected to the gate line G₁.

When the gate line G₁ is enabled, the transistors TFT1 and TFT2 are conducted and the data line D1 writes pixel driving voltages VP1 and VP2 to the pixel circuit 600. Under the condition of disregarding path consumption, the pixel driving voltages VP1 and VP2 are equal. When the gate line G2 is enabled, the common node 620 is conducted to the gray level voltage VCS through the transistor TFT3 so that a voltage level of the common node 620 (originally the pixel driving voltage VP2) is equal to the gray level voltage VCS (if considering the effect of charging and discharging the capacitor, the voltage level of the common node 620 gradually approaches the gray level voltage VCS). At this moment, the pixel driving voltage VP2 displays a black image or a gray image depending on a voltage value of the gray level voltage VCS.

Thus, the voltage levels of the common node 620 change even more rapidly after the gate line G₂ is enabled, and the effect of black/gray frame insertion appears more significant. Furthermore, the voltage levels of the gray level voltage VCS and the common voltage VCOM may be the same and achieve the effect of black/gray frame insertion as well. On the other hand, a black/gray signal is inputted to the sub pixel formed by the pixel capacitor CLC2 and the storage capacitor CST2 when the transistor TFT3 is turned on so that the black/gray insertion is achieved and the color washout effect is improved in the present embodiment. It is noted that the black/gray insertion can be achieved by adjusting an area ratio between the capacitor CLC1 and the capacitor CLC2.

FIG. 6B is a pixel layout diagram according to FIG. 6A, and dispositions of the transistors TFT1-TFT3 are arranged as illustrated by FIG. 6B. A pixel electrode 630 of the pixel capacitor CLC1 and a pixel electrode 640 of the pixel capacitor CLC2 are illustrated as FIG. 6B respectively. It is to be noted that FIG. 6B is merely one of a variety of layouts for the pixel circuit in FIG. 6A, and the present embodiment is not limited thereto.

### The Fourth Embodiment

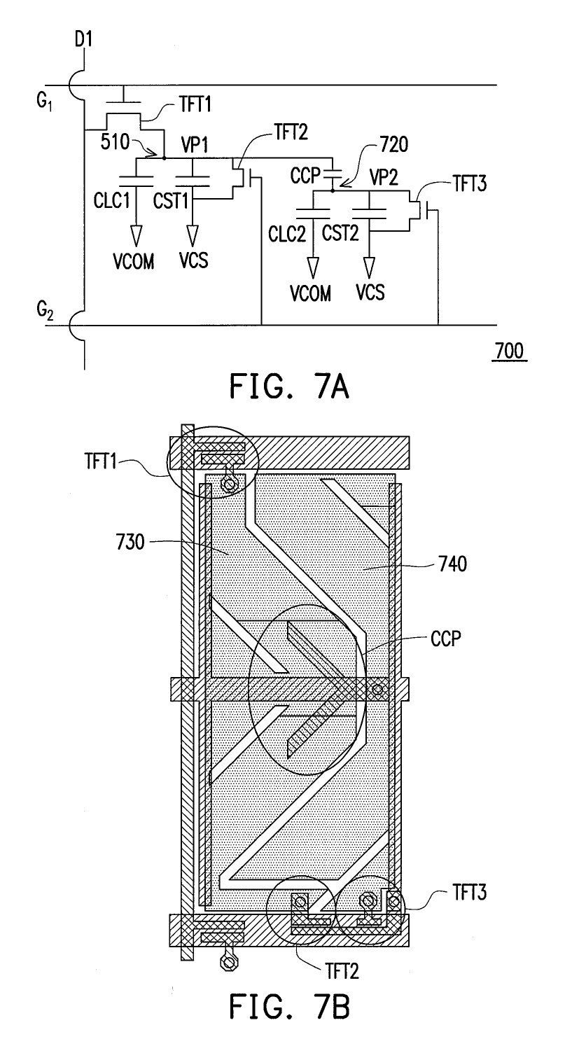

FIG. 7A is a pixel circuit diagram according to the fourth embodiment of the present invention. A pixel circuit 700 is another embodiment of the pixel circuit 111 and constituted similarly by two sub-pixel structures. The pixel circuit 700 includes transistors TFT1-TFT3, pixel capacitors CLC1 and CLC2, storage capacitors CST1 and CST2 and a coupling capacitor CCP. The coupling capacitor CCP is electrically connected between the common node 510 and a common node 720. The pixel capacitor CLC2 is electrically connected between the common node 720 and the common voltage VCOM. The storage capacitor CST2 is electrically connected between the common node 720 and the gray level voltage VCS. The transistor TFT3 is electrically connected between the common node 720 and the gray level voltage VCS, and the gate of the transistor TFT3 is electrically connected to the gate line G₂. A circuit structure of the pixel capacitor CLC1, the storage capacitor CST1 and the transistor TFT1 is similar to that of FIG. 5A and therefore is not reiterated.

When the gate line G₁ is enabled, the transistor TFT1 is conducted and the data line D1 transmits the pixel driving voltage VP1 to the common node 510. The transistor TFT1 is also coupled to the common node 720 through the coupling capacitor CCP to form the pixel driving voltage VP2. At this moment, the pixel circuit 700 is in a normal display status. When the gate line G₂ is enabled, the transistors TFT2 and TFT3 are conducted and both the common nodes 510 and 720 are conducted to the gray level voltage VCS so that the original pixel driving voltages VP1 and VP2 are equal to or approach the gray level voltage VCS. Now, the pixel circuit 700 is in a status of black/gray frame insertion.

FIG. 7B is a pixel layout diagram according to FIG. 7A, and dispositions of the transistors TFT1-TFT3 are arranged as illustrated by FIG. 7B. A pixel electrode 730 of the pixel capacitor CLC1, a pixel electrode 740 of the pixel capacitor CLC2 and the coupling capacitor CCP are disposed in a layout as illustrated by FIG. 7B. It is to be noted that FIG. 7B is merely one of a variety of layouts for the pixel circuit in FIG. 7A and the present embodiment is not limited thereto.

When the pixel circuits 500, 600 and 700 are applied to the pixel design of the display panel 110, data writing and black/gray frame insertion are performed simultaneously to coordinate with the driving method of scanning by every other gate line in the first embodiment so as to achieve the effect of black/gray frame insertion in FIGS. 3 and 4. Since an interval between enabling time of two adjacent gate lines lasts for half an image cycle, each of the pixels lasts for half an image cycle after data writing, and a next gate line is enabled to achieve black/gray frame insertion. In other words, during the second half of the image cycle, the pixel is conducted to the gray level voltage, and a driving waveform of the pixel is similar to a pulse-type driving waveform so as to improve display quality of the dynamic image.

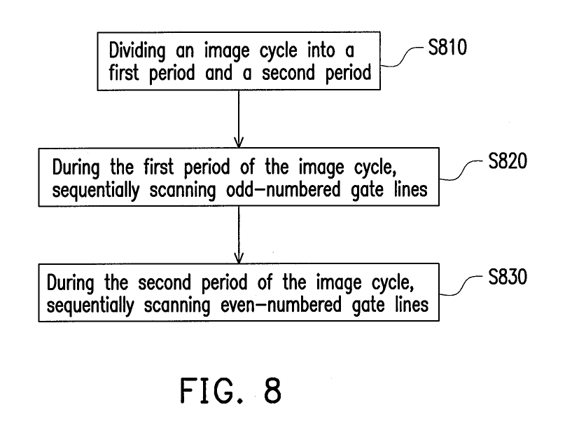

From the implementation methods and technical means as described in the foregoing embodiments, a driving method of a display adapted to the display panel and pixels in the said embodiments can be concluded. FIG. 8 is a flowchart illustrating a driving method of the display according to the present invention. If the display panel includes N pixel columns corresponding to N gate lines respectively, when an (i+1)^{th} gate line is enabled, an (i+1)^{th} pixel column is turned on to receive a plurality of pixel driving voltages transmitted by data lines. An i^{th} pixel column receives a gray level voltage; N and i are positive integers and 1≦i<N. The driving method of the present embodiment includes following steps. First, in step S810, an image cycle is divided into a first period and a second period. Afterwards, in step S820, during the first period of the image cycle, odd-numbered gate lines among the gate lines are scanned sequentially. In step S830, during the second period of the image cycle, even-numbered gate lines among the gate lines are scanned sequentially.

In other words, the gate lines in the display panel are driven by every other line such that adjacent gate lines can perform data writing and black/gray frame insertion respectively at the same time. During the first half of the image cycle, half of the gate lines in the display panel are scanned. During the second half of the image cycle, the other half of the gate lines in the display panel are scanned. Moreover, a sequence of scanning each of the images may also be changed (e.g. first scanning even-numbered gate lines and then odd-numbered ones) to coordinate with a driving polarity (dot inversion or column inversion), which means interchanging the sequence of the first and second periods. Other details of the driving method have all been described in the foregoing embodiments and will not be reiterated as they may be deduced by those having ordinary skill in the art according to the disclosure of the present invention.

In the present invention, timing control signals and a pixel circuit design different from the prior art are used to change the method each of the images is scanned into scanning by every other line. In the driving method, either odd-numbered lines first and then even-numbered lines are scanned or even-numbered lines first and then odd-numbered lines are scanned. As a result, data writing and black/gray frame insertion are performed in the LCD simultaneously. Further, in the present invention, the pixel circuit design does not require a complicated circuit design or an additional driving chip to achieve the effect of black/gray frame insertion. Further, the effect of black/gray frame insertion is not limited by image resolution.

It will be apparent to those skilled in the art that various modifications and alterations can be made to the structure of the present invention without departing from the scope or spirit of the invention. In view of the foregoing, it is intended that the present invention cover modifications and alterations of this invention provided they fall within the scope of the following claims and their equivalents.

What is claimed is:

1. A display panel, comprising:
N pixel columns, each of the pixel columns comprising a plurality of pixel circuits;
N gate lines, corresponding to the pixel columns, wherein an (i+1)^{th} gate line is electrically connected to the pixel circuits corresponding to an i^{th} pixel column and an (i+1)^{th} pixel column, i and N being positive integers, 1≦i<N; and
a plurality of data lines, corresponding to the pixel circuits of the pixel columns,
wherein when the (i+1)^{th} gate line is enabled, the (i+1)^{th} pixel column is turned on to receive a plurality of pixel driving voltages transmitted by the data lines and the i^{th} pixel column receives a first gray level voltage to perform black/gray frame insertion.

2. The display panel as claimed in claim 1, wherein each of the pixel circuits in the i^{th} pixel column comprises:
a first pixel capacitor, electrically connected between a first common node and a common voltage;
a first storage capacitor, one end of the first storage capacitor electrically connected to the first common node;
a first transistor, electrically connected between one of the data lines corresponding to the first transistor and the first common node, a gate of the first transistor electrically connected to the i^{th} gate line; and
a second transistor, electrically connected between the first common node and the first gray level voltage, a gate of the second transistor electrically connected to the (i+1)^{th} gate line.

3. The display panel as claimed in claim 2, wherein the other end of the first storage capacitor is electrically connected to the first gray level voltage or the common voltage.

4. The display panel as claimed in claim 2, wherein each of the pixel circuits on the i^{th} pixel column further comprises:
a coupling capacitor, electrically connected between the first common node and a second common node;
a second pixel capacitor, electrically connected between the second common node and the common voltage;
a second storage capacitor, one end of the second storage capacitor electrically connected to the second common node; and
a third transistor, electrically connected between the second common node and a second gray level voltage, a gate of the third transistor electrically connected to the (i+1)^{th} gate line.

5. The display panel as claimed in claim 4, wherein the other end of the second storage capacitor is electrically connected to the second gray level voltage or the common voltage.

6. The display panel as claimed in claim 1, wherein each of the pixel circuits in the i^{th} pixel column comprises:
a first pixel capacitor, electrically connected between a first common node and a common voltage;
a first storage capacitor, one end of the first storage capacitor electrically connected to the first common node;
a first transistor, electrically connected between one of the data lines corresponding to the first transistor and the first common node, a gate of the first transistor electrically connected to the i^{th} gate line;
a second transistor, electrically connected between the first common node and a second common node, a gate of the second transistor electrically connected to the i^{th} gate line;
a second pixel capacitor, electrically connected between the second common node and the common voltage;
a second storage capacitor, one end of the second storage capacitor electrically connected to the second common node; and
a third transistor, electrically connected between the second common node and the first gray level voltage, a gate of the third transistor electrically connected to the (i+1)^{th} gate line.

7. The display panel as claimed in claim 6, wherein the other ends of the first storage capacitor and the second storage capacitor are electrically connected to the first gray level voltage or the common voltage.

8. A pixel circuit, comprising:
a first pixel capacitor, electrically connected between a first common node and a common voltage;
a first storage capacitor, one end of the first storage capacitor electrically connected to the first common node;
a first transistor, electrically connected between a data line and the first common node, a gate of the first transistor electrically connected to a first gate line; and
a second transistor, electrically connected between the first common node and a first gray level voltage, a gate of the second transistor electrically connected to a second gate line,
wherein the first gate line and the second gate line are adjacent.

9. The pixel circuit as claimed in claim 8, wherein the other end of the first storage capacitor is electrically connected to the first gray level voltage or the common voltage.

10. The pixel circuit as claimed in claim 8, further comprising:
a coupling capacitor, electrically connected between the first common node and a second common node;
a second pixel capacitor, electrically connected between the second common node and the common voltage;
a second storage capacitor, one end of the second storage capacitor electrically connected to the second common node; and
a third transistor, electrically connected between the second common node and a second gray level voltage, a gate of the third transistor electrically connected to the second gate line.

11. The pixel circuit as claimed in claim 10, wherein the other end of the second storage capacitor is electrically connected to the second gray level voltage or the common voltage.

12. A pixel circuit, comprising:
a first pixel capacitor, electrically connected between a first common node and a common voltage;
a first storage capacitor, one end of the first storage capacitor electrically connected to the first common node;
a first transistor, electrically connected between a data line and the first common node, a gate of the first transistor electrically connected to a first gate line;
a second transistor, electrically connected between the first common node and a second common node, a gate of the second transistor electrically connected to the first gate line;
a second pixel capacitor, electrically connected between the second common node and the common voltage;
a second storage capacitor, one end of the second storage capacitor electrically connected to the second common node; and
a third transistor, electrically connected between the second common node and a first gray level voltage, a gate of the third transistor electrically connected to the second gate line,
wherein the first gate line and the second gate line are adjacent.

13. The pixel circuit as claimed in claim 12, wherein the other ends of the first storage capacitor and the second storage capacitor are electrically connected to the first gray level voltage or the common voltage.

14. A driving method adapted to a display panel, the display panel comprising N pixel columns corresponding to N gate lines respectively, wherein when an (i+1)^{th} gate line is enabled, an (i+1)^{th} pixel column is turned on to receive a plurality of pixel driving voltages transmitted by the data lines and an i^{th} pixel column receives a gray level voltage, N and i being positive integers and 1≦i<N, the driving method comprising:
dividing an image cycle into a first period and a second period;
scanning sequentially odd-numbered gate lines among the gate lines during the first period of the image cycle; and
scanning sequentially even-numbered gate lines among the gate lines during the second period of the image cycle.

15. The driving method as claimed in claim 14, wherein the second period follows the first period.

16. The driving method as claimed in claim 14, wherein the first period follows the second period.
